(19) United States
(12) Patent Application Publication
(10) Pub. No.: US 2013/0068104 A1
(43) Pub. Date: Mar. 21, 2013

(54) INTUMESCENT SEALANTS IN FILTERS AND OTHER EQUIPMENT

(71) Applicants: Erik P. Brown, Tracy, CA (US); Mark A. Mitchell, Dublin, CA (US); Ronald A. Beaulieu, Las Vegas, NV (US)

(72) Inventors: Erik P. Brown, Tracy, CA (US); Mark A. Mitchell, Dublin, CA (US); Ronald A. Beaulieu, Las Vegas, NV (US)

(73) Assignee: Lawrence Livermore National security, LLC, Livermore, CA (US)

(21) Appl. No.: 13/612,655

(22) Filed: Sep. 12, 2012

Related U.S. Application Data
(60) Provisional application No. 61/535,129, filed on Sep. 15, 2011.

(51) Int. Cl. B01D 46/00; F16J 15/02

(52) U.S. Cl. CPC B01D 46/0084; F16J 15/02
USPC 96/361; 55/502; 96/371; 277/316

(57) ABSTRACT

An equipment component system including an equipment component structure having a first unit and a second unit and an intumescent paint or sealant on said equipment component structure. The intumescent paint or sealant provides sealing or prevents warpage or deformation or separation of a equipment component or sub-component in a fire or at high temperatures. The intumescent paint can shut a gap in a fire or at high temperatures. The intumescent paint can also pen a gap in a fire or at high temperatures so that fluid flow is preferentially directed one route versus another.

### CROSS-REFERENCE TO RELATED APPLICATIONS

This application claims benefit under 35 U.S.C. §119(e) of U.S. Provisional Patent Application No. 61/535,129 filed Sep. 15, 2011 entitled “Use of intumescent sealants in filters and other equipment for self-sealing in a fire,” the disclosure of which is hereby incorporated by reference in its entirety for all purposes.

### STATEMENT AS TO RIGHTS TO INVENTIONS MADE UNDER FEDERALLY SPONSORED RESEARCH AND DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### BACKGROUND

1. Field of Endeavor

The present invention relates to filters and other equipment and more particularly to intumescent sealants in filters and other equipment.

2. State of Technology

The conventional disposable High Efficiency Particulate Air (HEPA) filter system used today was originated during World War II when the Allies became concerned for the soldiers who were being exposed to dense chemical fog used for camouflage and/or chemical warfare. Research for breathing apparatus to filter the chemical fog began with creating an aerosol of minimal and uniform particle size to use for instrumentation calibration. The resulting material was dioctyl phthalate (DOP), a pure phthalic ester. The DOP testing method is still used today. An improved filter media consisting of finely ground asbestos and large diameter support fibers was introduced during the early 1950's. This filter media demonstrated a filtering efficiency of 99.97% and was replaced just a few years later during the mid-1950's with a material boasting of uniformity and higher efficiency. We know this material today as fiberglass. The fiberglass material also demonstrated a minimum filtering efficiency of 99.97%; this specification for HEPA has remained unchanged and is still used today.

Most air/gas filter units are constructed the same way—a continuous length of filter media is folded back and forth into pleats and corrugated separators are inserted between each fold. The assembly is then sealed into a rigid, open-faced rectangle. The components of a fabricated filter include: (1) extensively pleated filter medium (including a binder), (2) separators that provide air passages and keep adjacent pleats apart, (3) a rigid filter case that encloses and protects the fragile filter medium, (4) sealants used to bond the filter pack (consisting of the assembled pleated medium and separators) to the filter case and to eliminate leak paths between filter pack components, and (5) gaskets attached to the filter case on one or both open faces to provide an airtight seal between the filter and the mounting frame.

Sealants used to provide a leak-free bond between the filter pack and case must be resistant to heat and moisture, noncombustible, fire-resistant, or self-extinguishing, as well as capable of maintaining a reliable seal under continuous exposure to design operating conditions. Rubber-based adhesives compounded with chlorine or bromine to ensure self-extinguishing when exposed to ignition are acceptable, but catalytically cured solid and foamed polyurethanes containing additives for combustion suppression are the sealants of choice for most filter manufacturers. Sealants should maintain their integrity over a wide temperature range. Filters designed to operate at temperatures above 392 degrees Fahrenheit (200 degrees Celsius) have been sealed with compression-packed glass fibers and with ceramic cements reinforced with glass fibers, and have been hardened thermally. Compression-packed glass fiber seals are sometimes found to be damaged after shipment. The ceramic seal is often too brittle to withstand commercial shipment. Room temperature vulcanizing silicone rubber sealants have been used successfully at operating temperatures only slightly lower than 392 degrees Fahrenheit (200 degrees Celsius).

Filters must be installed so that even the smallest volume of air or gas does not escape filtration; therefore, gaskets and alternative methods of sealing filter units to the mounting frames play a critical role in the satisfactory operation of filters, particularly HEPA filters. The most widely used sealing method is a flexible gasket attached to the open face of the filter case and pressed against the flat face of the mounting framework. The second most popular method is referred to as a “fluid seal.” This method uses a channel formed or routed in the peripheral face of the filter case that is filled with a highly viscous, very low volatility, nonflammable (or self-extinguishing), odor-free, non-Newtonian fluid such as a silicone. The fluid flows around and over imperfections, but does not relax or separate from the surfaces it contacts. For installation, the matching framework face is equipped with a continuously protruding knife-edge that mates with the fluid-filled channel in the filter case. The reverse arrangement of a protruding knife-edge on the filter and a fluid-filled channel on the mounting frame also may be employed. These two mounting methods do not have interchangeable parts, so hybrid sealing systems are not feasible.

Gaskets must be oil- and ozone-resistant. Closed-cell sponge gaskets composed of synthetic rubber (neoprene) that conforms to grade 2C3 or 2C4 of ASTM D1056, Sponge and Cellular Rubber Products have been widely used. Gaskets should have a minimum thickness of ¼ inch and width of ¾ inch. The gasket face attached to the filter case should be free of any adhesion-resistant mold-release contaminant that may have been acquired when the gasket material was molded. To ensure an absence of residual mold release chemical, only cut surfaces are permitted on both gasket faces. Gaskets may be cut out of a sheet of stock as a single piece or may be made of strips joined at the corners by dovetail or other interlocking arrangement. Joints are sealed against air leakage with a rubber-base adhesive, usually the same adhesive used to attach the gasket to the filter case. Manufacturers of neoprene gaskets recommend a shelf life not to exceed 3 years.

The recommended limitation for filter operating temperature is 250 degrees Fahrenheit. The filter media binder is assumed to be the HEPA filter component that is most susceptible to failure resulting from elevated temperature. The binder begins burning off at 350 degrees Fahrenheit. Commonly used sealants are highly susceptible to degradation at elevated temperatures. Tables 3.5 and 3.6 list continuous-service temperatures for wood- and steel-cased filters. At temperatures well below the char point of an elastomeric sealant, the sealant loses its shear strength, resulting in a reduction from approximately 6,000 kPa at room temperature to a low of 100 kPa at 300 degrees Fahrenheit. Air/gas filters exposed to thermal stress will begin to release contaminates at temperatures above 300 degrees Fahrenheit.

Water exposure is unquestionably an important factor leading to the deterioration of HEPA filters and their degradation to 0 percent efficiency when coupled with higher pressure drop. HEPA filters become weak and plug with water. One of the most common events is when people think no detrimental effects occur as a result of repeatedly wetting the filter and drying it. Tests have shown that repeat wetting and drying of a HEPA filter will cause the loss of half its strength. There also are very strong effects of operational time on the behavior of HEPA filters under wet conditions. Tests have shown that the binder starts to get soft and dissolves at high differential pressures. One of the most serious issues dealing with HEPA filters in DOE facilities is their potential for rupture during accidental fires and the resulting release of radioactive smoke. The water spray systems in the HEPA filter housings used in nearly all DOE facilities for protection against fires were designed under the assumption that the HEPA filters would not be damaged by the water spray. The most likely scenario for filter damage in these systems involves filter plugging by the water spray, followed by fan blowing out of the medium.

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention includes the use and application of intumescent material (e.g., sealant(s), paints, or coatings) in filters, gas collectors/scrubbers, and other equipment (e.g., units in ductwork or high temperature systems or systems that may come into contact with flame environments) for self-sealing and/or preventing warpage/deformation/separation of equipment components in a fire or high temperature excursions or standard operating conditions. The intumescent material may be applied in a coating or at specific interfaces (with or without gaskets). Intumescent paints/sealants are also a means to seal material interfaces at each end of the filter element. The present invention provides an equipment component system including an equipment component structure having a first unit and a second unit and an intumescent paint or sealant on said equipment component structure. The intumescent paint or sealant provides sealing or prevents warpage or deformation or separation of a equipment component or sub-component and/or opens a gap in a fire or at high temperatures.

The present invention has use in preventing leakage at material interfaces and providing fire resistance in filters, gas collectors, scrubbers, ductwork, demisters, and other equipment including units in high temperature systems or systems that may come into contact with flame environments. The gases could be radioactive, hazardous, or valuable gases. The fluids could contain radioactive, hazardous, or valuable particulate. The filters could be HEPA, clean room, sub-HEPA, or a process filters. This invention can be utilized in HEPA and non-HEPA filters, in ventilation/HVAC system, process gas system, and other systems that filter particulate in a fluid.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIGS. 1A through 1F illustrate one embodiment of a filter constructed in accordance with the present invention.

FIG. 2 illustrates another embodiment of a filter constructed in accordance with the present invention.

FIG. 3 illustrates one embodiment of ductwork constructed in accordance with the present invention.

FIG. 4 illustrates another embodiment of a filter constructed in accordance with the present invention.

FIG. 5 illustrates embodiments of systems constructed in accordance with the present invention.

### DETAILED DESCRIPTION OF SPECIFIC EMBODIMENTS

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

A Defense Nuclear Facility Safety Board (DNFSB) study found that conventional glass fiber HEPA filters are structurally weak and easily damaged by water or fires. Many HEPA filter units are constructed of wooden or stainless steel frames containing a fluted sheet of fiberglass. During the event of a fire the hot air generated causes the filter media to become dry and brittle, thus reducing its effectiveness. Also, the wooden frames as well as the filter media are threatened by consumption by the fire itself. The conventional HEPA filter media's effectiveness is also compromised by high humidity. The additional moisture causes the filter media to become weakened allowing it to become susceptible to tearing easily, causing breakthrough. (DNFSB, 1999)

The present invention includes the use/application of intumescent material (e.g., sealant(s), paints, or coatings) in filters (e.g., conventional, fiberglass, ceramic, metal, or otherwise), gas collectors/scrubbers (e.g., iodine), and other equipment (e.g., units in ductwork or high temperature systems or systems that may come into contact with flame environments or unique process systems) for self-sealing and/or preventing warpage/deformation/separation of equipment components in a fire or high temperature excursions or standard operating conditions. The intumescent material may be applied in a coating or at specific interfaces (e.g., with or without gaskets). Intumescent paints/sealants are also a means to seal material interfaces at each end of the filter element. Preventing leakage at material interfaces and providing fire resistance is a major feature of the invention. The gases could be radioactive, hazardous, or valuable gases. The fluids could contain radioactive, hazardous, or valuable particulate. The filter could be HEPA, clean room, sub-HEPA, or a process filter. This invention can be embodied in HEPA and non-HEPA filters, in ventilation/HVAC system, process gas system, and other systems that filter particulate in a fluid.

In one embodiment, the filter elements are a ceramic while the housing is a metal. They have different coefficients of thermal expansion. The intumescent sealant is added in rings around both ends of the filter element (dish and element on one end; limit ring and element on the other end). This prevents air leakage at the material interfaces and provides fire resistance.

One embodiment is the use of the sealant in a ceramic HEPA filter. The filter elements are a ceramic while the housing is a metal. They have different coefficients of thermal expansion. The intumescent sealant is added in rings around both ends of the filter element (e.g., dish and element on one end; limit ring and element on the other end). This prevents gas/particulate leakage at the material interfaces and provides fire resistance. The sealant may be added manually, with a tool, or automatically. Use of a tool can improve the quality of the application of the sealant, i.e., even distribution around the ring.

Another embodiment is the use of the sealant in a ceramic HEPA filter. The filter elements are a ceramic while the housing is a metal. They have different coefficients of thermal expansion. The intumescent sealant is added as a coating to surface(s) (e.g., plate(s)) on or around one or both ends of the filter element (e.g., dish and element on one end; limit ring and element on the other end). This prevents gas/particulate leakage at the material interfaces and provides fire resistance. The sealant may be added manually, with a tool, or automatically. Use of a tool can improve the quality of the application of the sealant, i.e., even distribution across the surface.

Another embodiment is the use of the sealant in a metal filter (e.g., HEPA, nonHEPA, HVAC or process filter). Different metal(s) may be used in such a filter. The internal components of the filter and the metal housing may have different coefficients of thermal expansion. The intumescent sealant is added in the space between the internal components and the housing. This may be done by applying the sealant to the internal components directly, indirectly, and/or to the housing and then assembling the filter, and/or after assembling the filter. This prevents gas/particulate leakage at the material interfaces and provides fire resistance. The sealant may be added manually, with a tool, or automatically. Use of a tool can improve the quality of the application of the sealant, i.e., even distribution.

Another embodiment is the use of the sealant in a metal filter (e.g., HEPA, nonHEPA, HVAC or process filter). Different metal(s) may be used in such a filter. The internal components of the filter and the metal housing may have different coefficients of thermal expansion. The intumescent sealant is added in rings around both ends of the filter element (e.g., dish and element on one end; limit ring and element on the other end). The intumescent sealant may also (or alternatively) be added as a coating to surface(s) (e.g., plate(s)) on or around one or both ends of the filter element (e.g., dish and element on one end; limit ring and element on the other end).

Another embodiment is the use of the sealant in a traditional HEPA filter (separator or separatorless). The internal components of the filter and the metal housing have different coefficients of thermal expansion. The intumescent sealant is added in the space between the internal components and the housing. This may be done by applying the sealant to the internal components directly, indirectly, and/or to the housing and then assembling the filter, and/or after assembling the filter. This prevents gas/particulate leakage at the material interfaces and provides fire resistance. The sealant may be added manually, with a tool, or automatically. Use of a tool can improve the quality of the application of the sealant, i.e., even distribution.

Another embodiment is the use of the sealant in a traditional HEPA filter (separator or separatorless) to replace the binder for the filter material (e.g., fiberglass). The intumescent sealant is added in the space between the wraps of filter material (which can be a continuous sheet) and/or the housing. This may be done by applying the sealant to the filter material directly, indirectly, and/or to the housing and then assembling the filter, and/or after assembling the filter. This prevents gas/particulate leakage at the material interfaces and provides fire resistance. The sealant may be added manually, with a tool, or automatically. Use of a tool can improve the quality of the application of the sealant, i.e., even distribution.

Another embodiment is the use of the sealant in a traditional HEPA filter (separator or separatorless) to replace the sealant and the binder for the filter material (e.g., fiberglass). The intumescent sealant is added in the space between the wraps of filter material (which can be a continuous sheet) and/or the housing. This may be done by applying the sealant to the filter material directly, indirectly, and/or to the housing and then assembling the filter, and/or after assembling the filter. This prevents gas/particulate leakage at the material interfaces and provides fire resistance. The sealant may be added manually, with a tool, or automatically. Use of a tool can improve the quality of the application of the sealant, i.e., even distribution.

Another embodiment is the use of the sealant in a demister (e.g., equipment to remove water/moisture from a gas stream) to replace the sealant and the binder for the filter material (e.g., felt). The intumescent sealant is added in the space between the wraps of filter material (which can be a continuous sheet) and/or the housing. This may be done by applying the sealant to the filter material directly, indirectly, and/or to the housing and then assembling the filter, and/or after assembling the filter. This prevents gas/particulate leakage at the material interfaces and provides fire resistance. The sealant may be added manually, with a tool, or automatically. Use of a tool can improve the quality of the application of the sealant, i.e., even distribution.

Another embodiment is the use of the sealant in a traditional activated carbon filter (e.g., to scrub/collect radioactive iodine gas during an incident at a nuclear reactor). The intumescent sealant is added in the space between the activated carbon and the metal housing. This may be done by applying the sealant to the filter material directly, indirectly, and/or to the housing and then assembling the filter, and/or after assembling the filter. This prevents gas/particulate leakage at the material interfaces and provides fire resistance. The sealant may be added manually, with a tool, or automatically. Use of a tool can improve the quality of the application of the sealant, i.e., even distribution.

Another embodiment is to use a sealant with a strong force of expansion at high temperatures to crimp, close, or shut an orifice, pipe, component, or piece of equipment during a fire or high temperature event. This may be done by applying the sealant to the material directly, indirectly, and/or to the external surface (e.g., housing) and then assembling the equipment, and/or after assembling the equipment. This prevents gas/particulate leakage at the material interfaces and provides fire resistance. The sealant may be added manually, with a tool, or automatically. Use of a tool can improve the quality of the application of the sealant, i.e., even distribution.

Another embodiment is to use a sealant with a weak force of expansion at high temperatures to fill a gap, orifice, pipe, component, or piece of equipment during a fire or high temperature event. This may be done by applying the sealant to the material directly, indirectly, and/or to the external surface (e.g., housing) and then assembling the equipment, and/or after assembling the equipment. This prevents gas/particulate leakage at the material interfaces and provides fire resistance. The sealant may be added manually, with a tool, or automatically. Use of a tool can improve the quality of the application of the sealant, i.e., even distribution.

Another embodiment is to use a mix of sealants (e.g., with a strong and a weak force of expansion at high temperatures) to fill a gap, orifice, pipe, component, or piece of equipment during a fire or high temperature event. This may be done by applying the sealant to the material directly, indirectly, and/or to the external surface (e.g., housing) and then assembling the equipment, and/or after assembling the equipment. This prevents gas/particulate leakage at the material interfaces and provides fire resistance. The sealant may be added manually, with a tool, or automatically. Use of a tool can improve the quality of the application of the sealant, i.e., even distribution.

Another embodiment is to use one or more sealants to open and/or fill and/or to crimp, close, or shut a gap, orifice, pipe, component, or piece of equipment during a fire or high temperature event such that fluid flow is preferentially directed one route versus another (e.g., through the filtering material or gas collecting/scrubbing material). This may be done by applying the sealant to the material directly, indirectly, and/or to the external surface (e.g., housing) and then assembling the equipment, and/or after assembling the equipment. This prevents gas/particulate leakage at the material interfaces and provides fire resistance. The sealant may be added manually, with a tool, or automatically. Use of a tool can improve the quality of the application of the sealant, i.e., even distribution.

These advantages include embodiments that provide a filter having an efficiency of 99.97% for 0.3 micron DOP particles with low pressure drop in a form that can be resistant to high temperatures, corrosive environments, and have other advantages previously described. These advantages include other embodiments that provide filters for other filtration levels such as ultrafiltration and sub-HEPA filtration. Table 1 below provides examples of other filtration levels that are achieved by filters of the present invention.

TABLE 1
European Normalisation standards filter classes

| | | | | Particulate | |
|---|---|---|---|---|---|
| | | | | size | |
| | | | | approaching | |
| | | Perform- | Performance | 100% | Test |
| Usage | Class | ance | test | retention | Standard |
| Primary | G1 | 65% | Average value | >5 μm | BS EN779 |
| filters | G2 | 65-80% | Average value | >5 μm | BS EN779 |
| | G3 | 80-90% | Average value | >5 μm | BS EN779 |
| | G4 | 90%- | Average value | >5 μm | BS EN779 |
| | F5 | 40-60% | Average value | >5 μm | BS EN779 |
| | F6 | 60-80% | Average value | >2 μm | BS EN779 |
| Secondary | F7 | 80-90% | Average value | >2 μm | BS EN779 |
| filters | F8 | 90-95% | Average value | >1 μm | BS EN779 |
| | F9 | 95%- | Average value | >1 μm | BS EN779 |
| | H10 | 85% | Minimum | >1 μm | BS EN1822 |
| | | | value | | |
| Semi Hepa | H11 | 95% | Minimum | >0.5 μm | BS EN1822 |
| | | | value | | |
| | H12 | 99.5% | Minimum | >0.5 μm | BS EN1822 |
| | | | value | | |
| Hepa | H13 | 99.95% | Minimum | >0.3 μm | BS EN1822 |
| | | | value | | |
| | H14 | 99.995% | Minimum | >0.3 μm | BS EN1822 |
| | | | value | | |

The present invention is further described and illustrated by a number of examples of system constructed in accordance with the present invention. Various changes and modifications of these examples will be apparent to those skilled in the art from the description of the examples and by practice of the invention. The scope of the invention is not intended to be limited to the particular examples disclosed and the invention covers all modifications, equivalents, and alternatives falling within the spirit and scope of the invention as defined by the claims.

### Example 1

### Tubular Filter

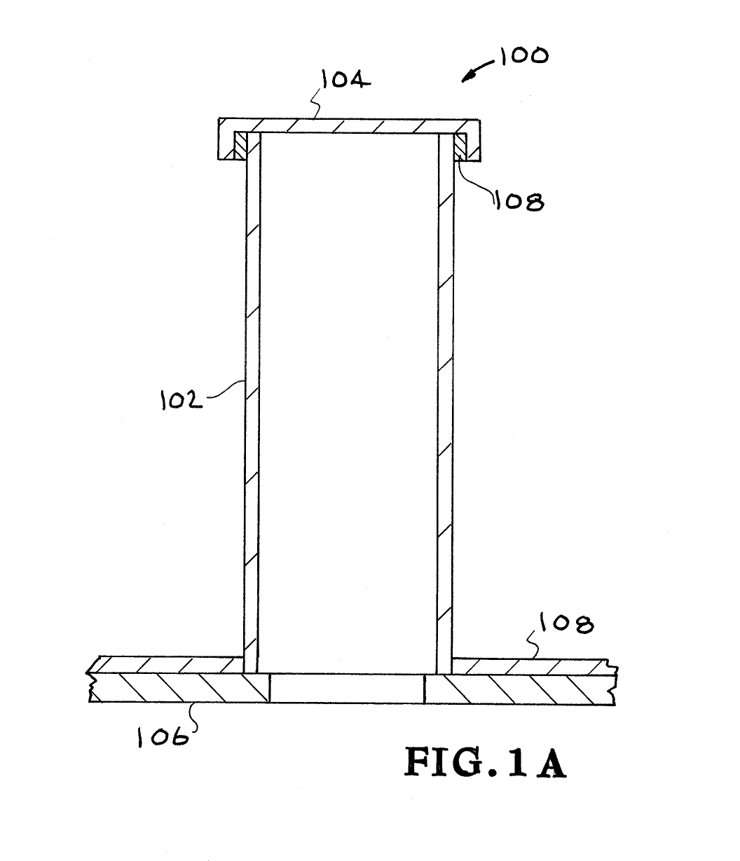

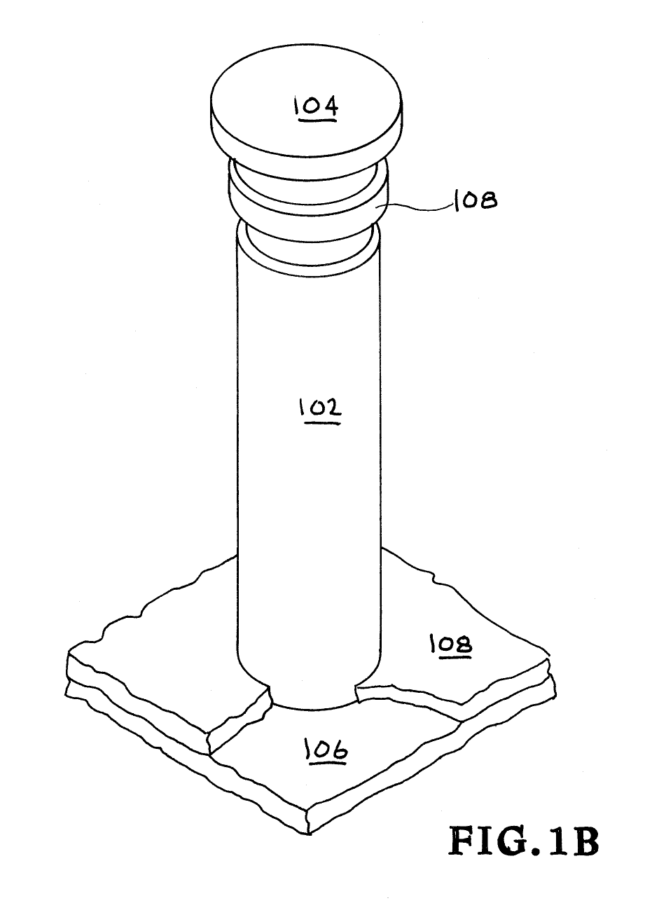

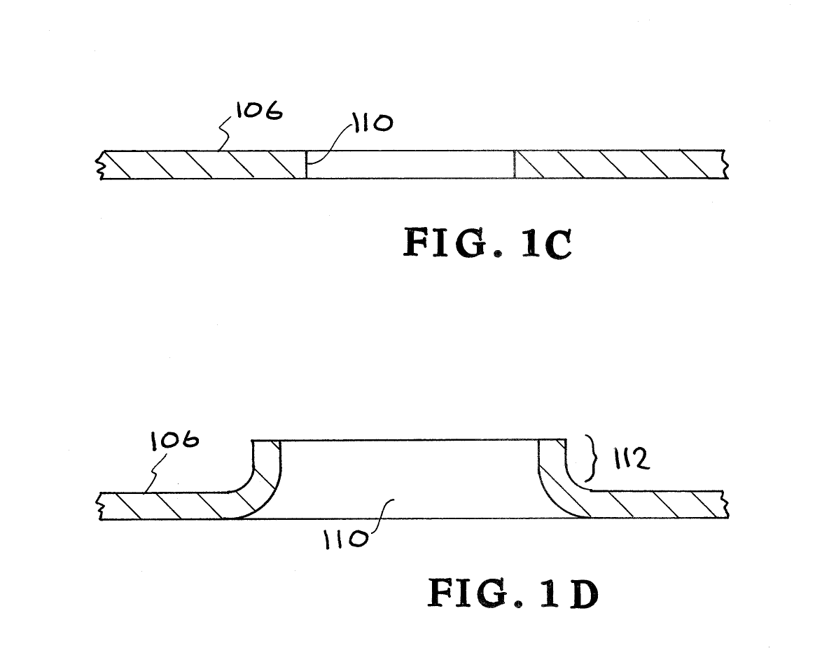

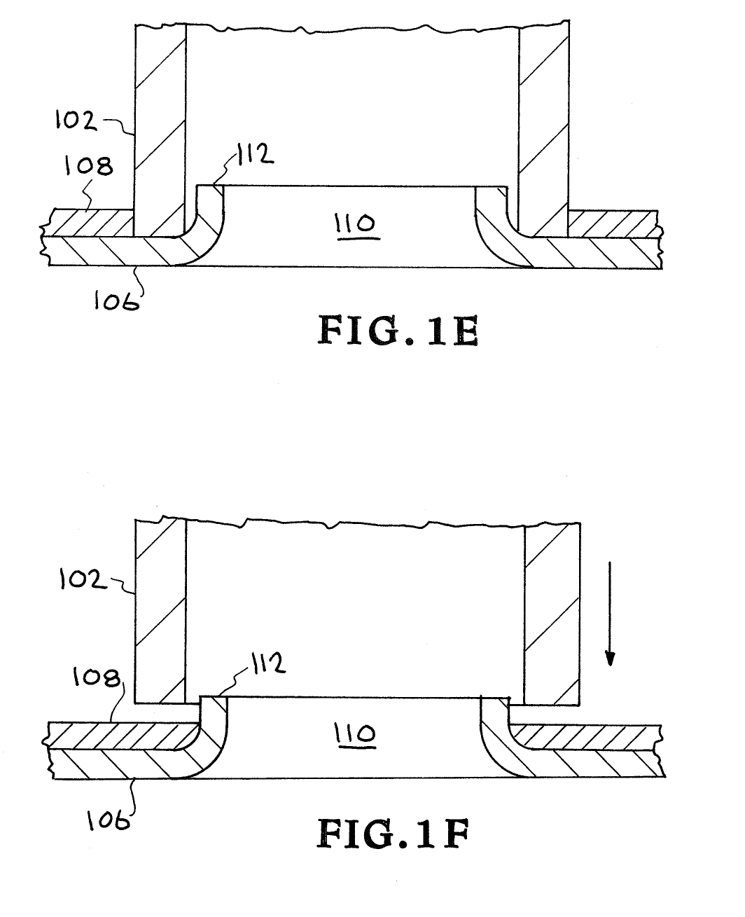

Referring now to the drawings and in particular to FIGS. 1A through 1F, one embodiment of a filter system constructed in accordance with the present invention is illustrated. The filter system is designated generally by the reference numeral 100.

The filter system 100 includes a tubular filter element 102. The tubular filter element 102 is closed at the top as illustrated by the top unit 104 positioned over the tubular filter element 102. The top unit 104 is a cover or cap that is sealed to the filter element by intumescent material 108. The intumescent material 108 may be applied in a coating or at specific interfaces (with or without gaskets). The intumescent material 108 is a material that undergoes a chemical change when exposed to heat or flames, becoming viscous then forming expanding bubbles that harden into a dense, heat insulating multi-cellular char. This expanding char can seal, insulate, and protect mating surfaces and joints, helping to prevent warping, subsequent leakage and damage.

The tubular filter element 102 is closed at the top by the top unit 104. This causes flow of the fluid being filter to pass from the outside of the tubular filter element 102 through the sides of the tubular filter element 102 into the internal passage of the tubular filter element 102. The tubular filter element 102 is made of filtering material or a filtering material is on the tubular filter element and the fluid is filtered as it passes through the sides of the tubular filter element 102 into the internal passage of the tubular filter element. The tubular filter element 102 is open at the bottom to allow fluid flow from the internal passage of the tubular filter element 102 out the bottom open end of the tubular filter element 102.

The filter element 102 is positioned over a hole in the base or support plate 106. The filter element 102 is sealed to the base or support plate 106 by intumescent material 108. The intumescent material 108 may be applied in a coating or at specific interfaces (with or without gaskets). The intumescent material 108 is a material that undergoes a chemical change when exposed to heat or flames, becoming viscous then forming expanding bubbles that harden into a dense, heat insulating multi-cellular char. This expanding char can seal, insulate, and protect mating surfaces and joints, helping to prevent warping, subsequent leakage and damage. The intumescent material may also be compliant allowing for differential thermal expansion between the filter and supporting structure.

Referring now to FIGS. 1C through 1F, the sealing of the filter element 102 to the base or support plate 106 is illustrated. As shown in FIG. 1C, a hole 110 is made in the base or support plate 106. The hole 110 is then swaged to produce a dimple or ring 112 on the base or support plate 106 as illustrated in FIG. 1D.

A first operation of sealing of the filter element 102 to the base or support plate 106 is illustrated in FIG. 1E. The filter element 102 is positioned over the hole 110 in the base or support plate 106 and over the dimple or ring 112 and the filter element 102 is moved into final position. The filter element may or may not have been pre-dipped in intumescent material. The connection between the filter element 102 and the base or support plate 106 forms a joint. The intumescent material 108 is flooded onto the base or support plate 106 as shown in FIG. 1E. The intumescent material 108 may be applied in a coating or at specific interfaces (with or without gaskets). The intumescent material 108 provides a seal in the joint between the filter element 102 and the base or support plate 106. The intumescent material 108 is a material that undergoes a chemical change when exposed to heat or flames, becoming viscous then forming expanding bubbles that harden into a dense, heat insulating multi-cellular char. This expanding char can seal, insulate, and protect mating surfaces and joints, helping to prevent warping, subsequent leakage and damage. The intumescent material may also be compliant allowing for differential thermal expansion between the filter and supporting structure.

A second operation of sealing of the filter element 102 to the base or support plate 106 is illustrated in FIG. 1F. The filter element 102 is positioned above the hole 110 in the base or support plate 106. The intumescent material 108 is flooded onto the base or support plate 106 as shown in FIG. 1F. The intumescent material 108 floods up to the dimple or ring 112 on the base or support plate 106. The filter element 102 is moved into final position over the hole 110 in the base or support plate 106 and over the dimple or ring 112. The connection between the filter element 102 and the base or support plate 106 forms a joint. The intumescent material 108 seals the filter element 102 to the base or support plate 106. The intumescent material 108 provides a seal in the joint between the filter element 102 and the base or support plate 106. The intumescent material 108 may be applied in a coating or at specific interfaces (with or without gaskets). The intumescent material 108 is a material that undergoes a chemical change when exposed to heat or flames, becoming viscous then forming expanding bubbles that harden into a dense, heat insulating multi-cellular char. This expanding char can seal, insulate, and protect mating surfaces and joints, helping to prevent warping, subsequent leakage and damage. The intumescent material may also be compliant allowing for differential thermal expansion between the filter and supporting structure.

### Example 2

### Tubular Filter Elements in a Filter Enclosure

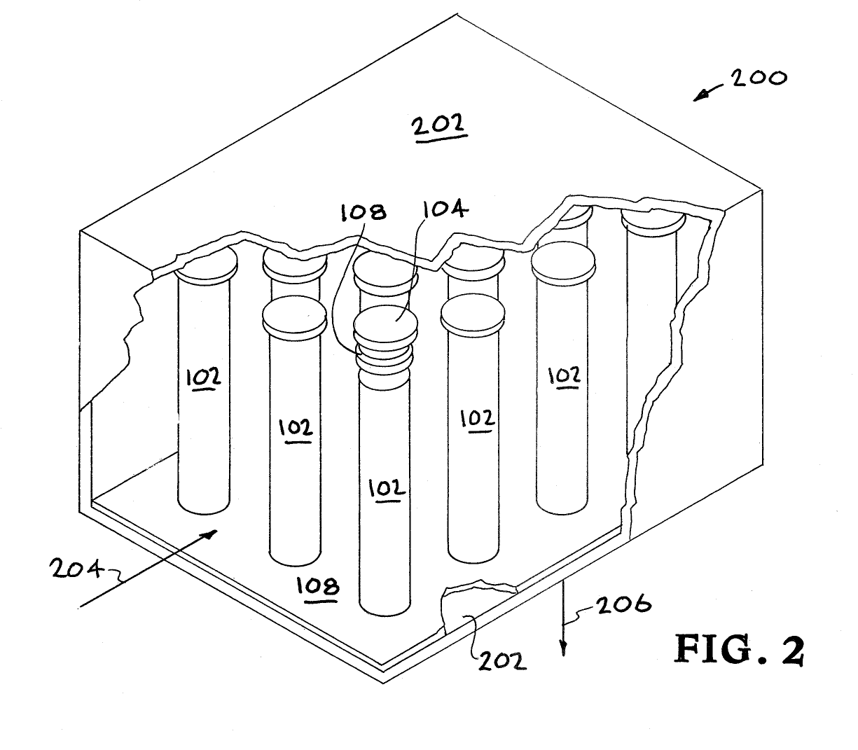

Another embodiment of a filter system constructed in accordance with the present invention is illustrated in FIG. 2. The filter system of this embodiment is designated generally by the reference numeral 200. The filter system 200 includes a filter enclosure 202. A series of the tubular filter elements 102 illustrated in FIGS. 1A through 1F are contained in the filter enclosure 202. The tubular filter elements 102 are closed at the top as illustrated by the covers or caps 104. The tubular filter elements 102 are mounted on a surface of the filter enclosure 202 in a manner that provides a fluid tight seal between the filter element and the surface of the filter enclosure 202. The tubular filter elements 102 have an open end that provides a fluid passage from the internal passage of the tubular filter elements 102 to the outside of the filter enclosure 202.

The fluid to be filtered is illustrated entering the enclosure 202 by the arrow 204. The tubular filter elements 102 are closed at the top and open at the bottom to create fluid flow from the outside of the tubular filter elements 102 through the sides of the tubular filter elements 102 into the internal passage of the tubular filter elements 102 and out the bottom open ends of the tubular filter elements 102. The fluid to be filtered is illustrated exiting the enclosure 202 by the arrow 206. The elongated tubular filter elements are made of filtering material or a filtering material is on each of the individual elongated tubular filter elements and the fluid being filtered passes through the filter material.

The top unit 104 is a cover or cap that is sealed to the filter element by intumescent material 108. The intumescent material 108 may be applied in a coating or at specific interfaces (with or without gaskets). The intumescent material 108 is a material that undergoes a chemical change when exposed to heat or flames, becoming viscous then forming expanding bubbles that harden into a dense, heat insulating multi-cellular char. This expanding char can seal, insulate, and protect mating surfaces and joints, helping to prevent warping, subsequent leakage and damage. The intumescent material may also be compliant allowing for differential thermal expansion between the filter and supporting structure.

The tubular filter element 102 is open at the bottom to allow fluid flow from the internal passage of the tubular filter element 102 out the bottom open end of the tubular filter element 102. The filter element 102 is positioned over a hole in the base of the enclosure 202. The connection between the filter element 102 and the base forms a joint. The filter element 102 is sealed to the base by intumescent material 208. The intumescent material 108 provides a seal in the joint between the filter element 102 and the base. The intumescent material 208 may be applied in a coating or at specific interfaces (with or without gaskets). The intumescent material 208 is a material that undergoes a chemical change when exposed to heat or flames, becoming viscous then forming expanding bubbles that harden into a dense, heat insulating multi-cellular char. This expanding char can seal, insulate, and protect mating surfaces and joints, helping to prevent warping, subsequent leakage and damage.

### Example 3

### Ductwork

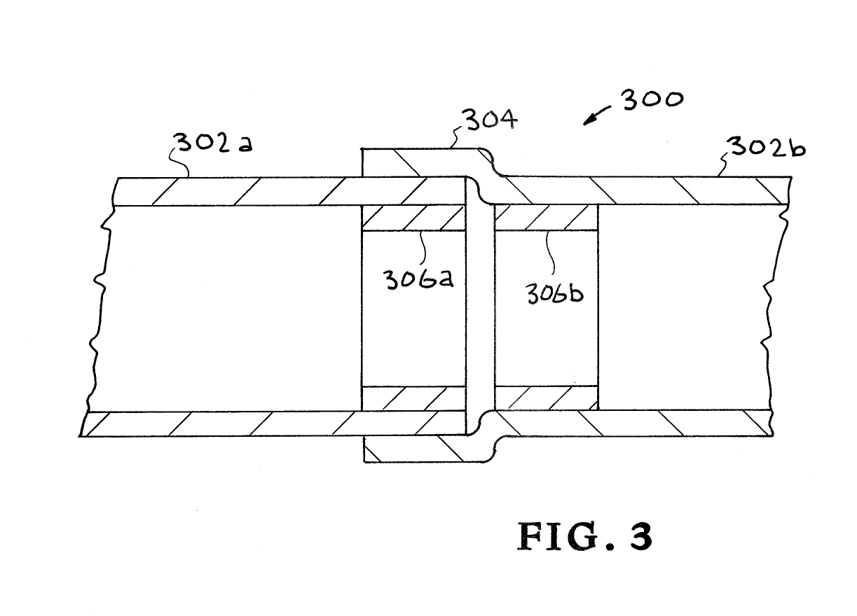

Referring now to FIG. 3, one embodiment of a ductwork system constructed in accordance with the present invention is illustrated. The ductwork system is designated generally by the reference numeral 300. The ductwork system 300 includes a first duct 302a and second duct 302b. As illustrated in FIG. 3, the second duct 302b has an expanded section 304 that serves as a collar to connect the first duct 302a and the second duct 302b. The expanded section 304 could also be a separate piece that would serves as a collar to connect the first duct 302a and the second duct 302b.

As illustrated in FIG. 3, the intumescent material 306a and 306b are located adjacent the first duct 302a and the second duct 302b. The intumescent material 306a is located adjacent the first duct 302a. The intumescent material 306b is located adjacent the second duct 302b. The connection between the first duct 302a and the second duct 302b forms a joint. It is to be noted that in FIG. 3 the intumescent material 306a and 306b are located adjacent the first duct 302a and the second duct 302b and not in the joint between the first duct 302a and the second duct 302b. In another embodiment the intumescent material is located in the joint between the first duct 302a and the second duct 302b. The intumescent material 308 may be applied in a coating or at specific interfaces (with or without gaskets). The intumescent material 308 is a material that undergoes a chemical change when exposed to heat or flames, becoming viscous then forming expanding bubbles that harden into a dense, heat insulating multi-cellular char. This expanding char can seal, insulate, and protect mating surfaces and joints, helping to prevent warping, subsequent leakage and damage. The intumescent material may also be compliant allowing for differential thermal expansion between the filter and supporting structure.

### Example 4

### Continuous Sheet Filter

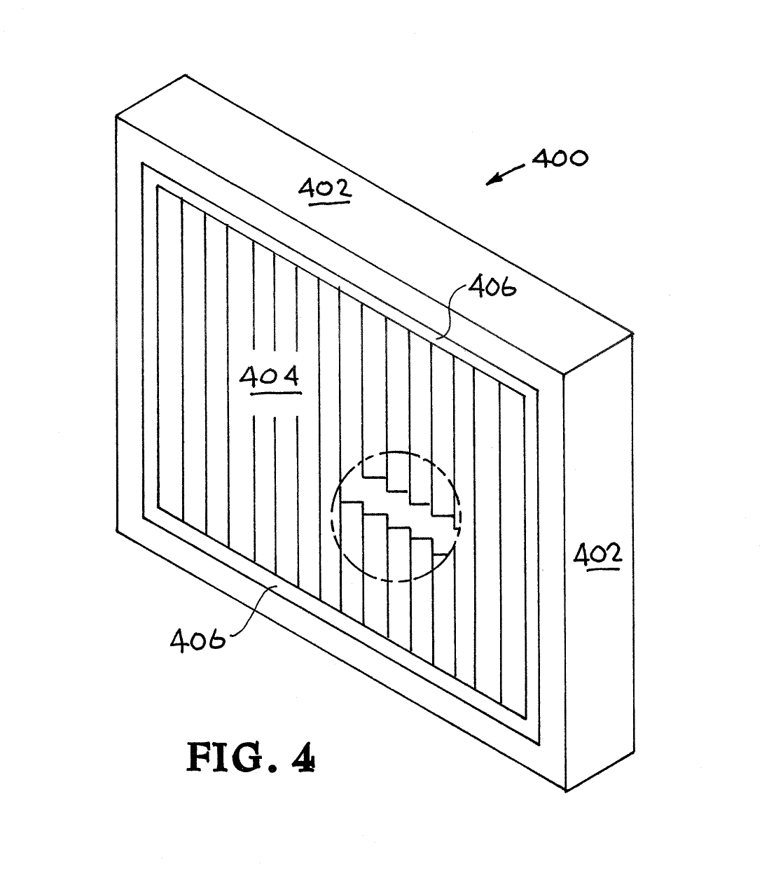

Another embodiment of a filter system constructed in accordance with the present invention is illustrated in FIG. 4. The filter system of this embodiment is designated generally by the reference numeral 400. The filter system 400 includes a filter casing 402. A series of the corrugated filter elements 404 are contained in the filter casing 402. The corrugated filter elements 404 are mounted on a surface of the filter casing 402 in a manner that provides a fluid tight seal between the filter element and the surface of the filter casing 402.

The filter elements 404 are sealed to the filter casing 402 by intumescent material 406. The area between the filter elements 404 and the filter casing 402 is considered a joint. The intumescent material 406 may be applied in a coating or at specific interfaces (with or without gaskets). The intumescent material 406 may be applied in or approximate to the joint between the filter elements 404 and the filter casing 402. The intumescent material 406 is a material that undergoes a chemical change when exposed to heat or flames, becoming viscous then forming expanding bubbles that harden into a dense, heat insulating multi-cellular char. This expanding char can seal, insulate, and protect mating surfaces and joints, helping to prevent warping, subsequent leakage and damage. The intumescent material may also be compliant allowing for differential thermal expansion between the filter and supporting structure.

### Example 5

### Equipment System

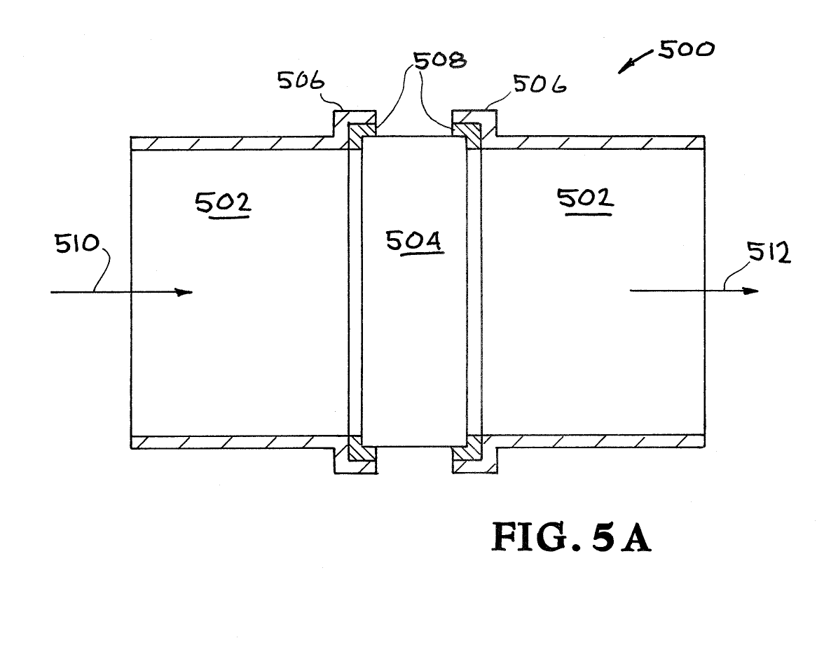

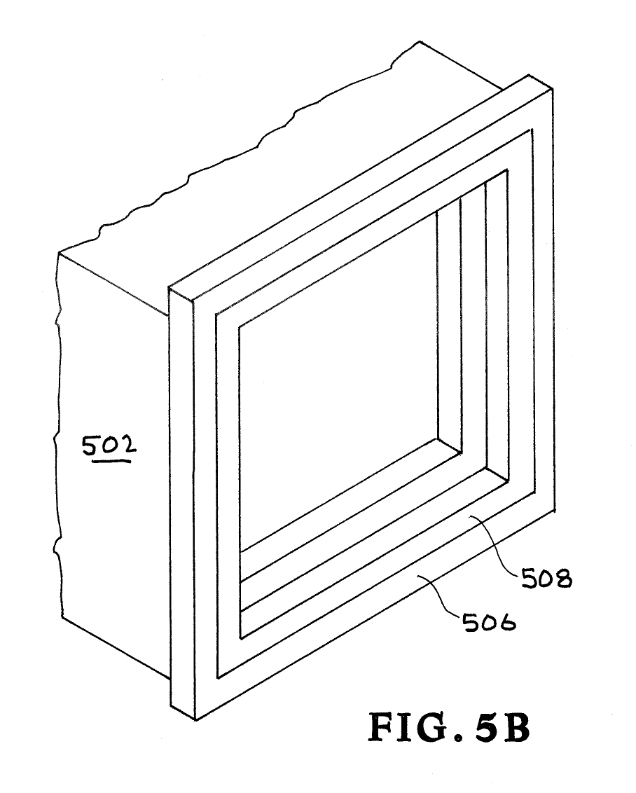

another embodiment of a system constructed in accordance with the present invention is illustrated in FIGS. 5A and 5B. The system of this embodiment is designated generally by the reference numeral 500.

As illustrated in FIG. 5A, the system 500 is an equipment component located in a fluid stream. The reference numeral 504 designates the gas collector system or scrubber system or demister system or other system. Ductwork is connected to the system 504. The ductwork includes a first duct and second duct both of which are designated by the reference numeral 502. A fluid enters the system 500 and is directed to the gas collector system or scrubber system or demister system or other system 504 through one of the ducts 502 as illustrated by the arrow 510. The fluid leaves the system 500 from the gas collector system or scrubber system or demister system or other system 504 through the other duct 502 as illustrated by the arrow 512.

As illustrated in FIG. 5B, the intumescent material 508 is located adjacent the connection between the gas collector system or scrubber system or demister system or other system 504 and the ducts 502. The connection forms a joint. The intumescent material 508 is located in or proximate to the joint between the gas collector system or scrubber system or demister system or other system 504 and the ducts 502. The intumescent material 508 may be applied in a coating or at specific interfaces (with or without gaskets). The intumescent material 508 is a material that undergoes a chemical change when exposed to heat or flames, becoming viscous then forming expanding bubbles that harden into a dense, heat insulating multi-cellular char. This expanding char can seal, insulate, and protect mating surfaces and joints, helping to prevent warping, subsequent leakage and damage. The intumescent material may also be compliant allowing for differential thermal expansion between the filter and supporting structure.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. An equipment component apparatus, comprising:
an equipment component structure having a first unit and a second unit,
an intumescent paint or sealant on said equipment component structure.

2. The equipment component apparatus of claim 1 further comprising a joint between said first unit and said second unit and wherein said intumescent paint or sealant is located in said joint or adjacent said joint.

3. The equipment component apparatus of claim 1 wherein the equipment component is a filter and wherein said first unit is a filter element and said second unit is a housing and wherein said intumescent paint or sealant is located between said filter element and said housing.

4. The equipment component apparatus of claim 1 wherein said first unit is a gas collector or a scrubber or a demister and wherein said second unit is a conduit connected to said gas collector or scrubber or demister and wherein said intumescent paint or sealant is located between said first unit and said second unit.

5. The equipment component apparatus of claim 1 wherein the equipment component is ductwork and wherein said first unit is a first duct and wherein said second unit is a second duct and wherein said intumescent paint or sealant is located between said first duct and said second duct.

6. The equipment component apparatus of claim 1 further comprising a joint between said first unit and said second unit and wherein the equipment component is ductwork and wherein said first unit is a first duct and wherein said second unit is a second duct and wherein said intumescent paint or sealant is located adjacent said first duct and said second duct.

7. An equipment component apparatus, comprising:
an equipment component structure having a first unit and a second unit,
intumescent paint or sealant means on said equipment component structure for sealing or preventing warpage or deformation or separation of an equipment component in a fire or at high temperatures.

8. The equipment component apparatus of claim 7 further comprising a joint between said first unit and said second unit and wherein said intumescent paint or sealant means is located in said joint or adjacent said joint.

9. The equipment component apparatus of claim 7 wherein the equipment component is a filter and wherein said first unit is a filter element and said second unit is a housing and wherein said intumescent paint or sealant means is located between said filter element and said housing.

10. The equipment component apparatus of claim 7 wherein said first unit is a gas collector or a scrubber or a demister and wherein said second unit is a conduit connected to said gas collector or scrubber or demister and wherein said intumescent paint or sealant means is located between said first unit and said second unit.

11. The equipment component apparatus of claim 7 wherein the equipment component is ductwork and wherein said first unit is a first duct and wherein said second unit is a second duct and wherein said intumescent paint or sealant means is located between said first duct and said second duct.

12. The equipment component apparatus of claim 7 further comprising a joint between said first unit and said second unit and wherein the equipment component is ductwork and wherein said first unit is a first duct and wherein said second unit is a second duct and wherein said intumescent paint or sealant means is located adjacent said first duct and said second duct.

13. A method of self-sealing or preventing warpage or deformation or separation of an equipment component in a fire or at high temperatures, comprising the steps of:
painting or coating or injecting the equipment component with intumescent paints or sealants.

14. The method of self-sealing or preventing warpage or deformation or separation of an equipment component in a fire or at high temperatures of claim 13 wherein the equipment component has a surface and has sub-components and wherein said step of painting or coating or injecting the equipment component with intumescent paints or sealants comprises painting or coating or injecting said components or painting or coating or injecting between said sub-components components and said surface of the equipment component.

15. The method of self-sealing or preventing warpage or deformation or separation of equipment component in a fire or at high temperatures of claim 13 wherein the equipment component is a filter having a first end and a second end and further comprising the step of painting or coating said first end and said second end of the equipment component with intumescent paints or sealants.

16. A method of self-sealing or preventing warpage or deformation or separation of an equipment component and/or opening a gap in a fire or at high temperatures, involving one or more sealants to open and/or fill and/or to crimp, close, or shut a gap, orifice, pipe, component, or piece of equipment during a fire or high temperature event such that fluid flow is preferentially directed one route versus another through the equipment component, comprising the steps of:
painting or coating or injecting the equipment component with intumescent paints or sealants.

17. A method of self-sealing or preventing warpage or deformation or separation of an equipment component and/or opening a gap in a fire or at high temperatures, involving one or more sealants to open and/or fill and/or to crimp, close, or shut a gap, orifice, pipe, component, or piece of equipment during a fire or high temperature event such that fluid flow is preferentially directed one route versus another through the equipment component of claim 16 wherein said step of painting or coating or injecting intumescent paints or sealants on and/or in components, between components and the external surface of the equipment component.
